(19) United States
(12) Patent Application Publication
(10) Pub. No.: US 2026/0309220 A1
(43) Pub. Date: Oct. 8, 2026

(54) VEHICLE DRIVING APPARATUS AND VEHICLE

(71) Applicant: QI AUTOMOTIVE CO., LTD., Qingdao (CN)

(72) Inventors: Guanqun LI, Qingdao, Shandong (CN); Baohua ZHANG, Beijing (CN); Minghan CAO, Qingdao, Shandong (CN); Fengmin WANG, Beijing (CN); Junzhi WANG, Qingdao, Shandong (CN); Fajia WANG, Beijing (CN); Fan YANG, Qingdao, Shandong (CN); Feiya ZHAO, Beijing (CN); Xiangyun LIU, Qingdao, Shandong (CN); Dongxu CUI, Beijing (CN)

(21) Appl. No.: 19/172,763

(22) Filed: Apr. 8, 2025

(51) Int. Cl. F16H 57/00; B60K 17/344; B60K 23/08; F16D 27/105; F16H 1/06; F16D 127/02

(52) U.S. Cl. CPC F16H 57/0006; B60K 17/344; B60K 23/08; F16D 27/105; F16H 1/06; F16D 2127/02; F16D 2500/10431; F16D 2500/1107

(57) ABSTRACT

Disclosed are a vehicle driving apparatus and a vehicle. The vehicle driving apparatus includes a housing, a driven gear axial adjusting mechanism, and a driving gear and a driven gear both located inside the housing. The driving gear and the driven gear are meshed for transmission connection. The driven gear axial adjusting mechanism includes an adjusting component and a wear-resistant block, the wear-resistant block is fixed inside the housing through the adjusting component, and the wear-resistant block abuts against an axial end face of the driven gear.

### TECHNICAL FIELD

The disclosure relates to the field of vehicle driving technology, in particular to a vehicle driving apparatus and a vehicle.

### BACKGROUND

In vehicle drive apparatuses, gears may wear during transmission. When the gears become worn, the axial dimensions of the gears may change, resulting in noticeable axial runout during operation. This leads to increased vibration and noise in the entire drive system.

### SUMMARY

Embodiments of the disclosure provide a vehicle driving apparatus and a vehicle, to stabilize the axial positions of gears, thereby reducing vibration and noise in the driving system.

In one aspect, embodiments of the disclosure provide a vehicle driving apparatus, including: a housing; a driven gear axial adjusting mechanism; and a driving gear and a driven gear both located inside the housing. The driving gear and the driven gear are meshed for transmission connection. The driven gear axial adjusting mechanism includes an adjusting component and a wear-resistant block, the wear-resistant block is fixed inside the housing through the adjusting component, and the wear-resistant block abuts against an axial end face of the driven gear.

In some embodiments, the wear-resistant block includes a wear-resistant layer, a vibration-absorbing layer, and a support layer arranged in a stack. A side of the wear-resistant layer facing away from the vibration-absorbing layer abuts against the axial end face of the driven gear.

In some embodiments, a material of the wear-resistant layer includes polytetrafluoroethylene and lead; and/or, a material of the vibration-absorbing layer includes tin bronze; and/or, a material of the support layer includes mild steel.

In some embodiments, the wear-resistant block further includes a protective layer stacked on a side of the support layer facing away from the vibration-absorbing layer.

In some embodiments, the protective layer includes an electroplated copper layer.

In some embodiments, the housing includes a housing cover provided with an adjusting hole. The adjusting component includes an adjusting bolt and an adjusting nut. A first end of the adjusting bolt passes through the adjusting hole and extends outside the housing, a second end of the adjusting bolt connects the wear-resistant block and is in sealing connection with the adjusting hole. The adjusting nut is fixed to the housing cover by means of a thread fit with the first end of the adjusting bolt.

In some embodiments, a boss is provided on a side of the housing cover facing the driven gear. The wear-resistant block includes a plurality of bending portions arranged in a circular manner around the adjusting bolt to form an accommodation space for accommodating the boss.

In some embodiments, the vehicle driving apparatus further includes a driven gear shaft, an output half shaft, a roller cage assembly, and an electromagnetic switching mechanism. The roller cage assembly is sleeved on an inner side of the driven gear shaft. The roller cage assembly includes a cage, a roller group and an annular elastic element, and the roller group includes a plurality of pin rollers. A side surface of each pin roller is provided with a groove for mounting the annular elastic element. The roller group and the annular elastic element are both installed on the cage. Along a radial direction of the cage, the annular elastic element is positioned between the cage and the roller group, so that the cage is in transmission connection with the driven gear shaft through the roller group. An inner surface of the driven gear shaft is formed with a plurality of cannelures, and one cannelure is used for accommodating one pin roller in the roller group. The output half shaft is sleeved on an inner side of the cage. The electromagnetic switching mechanism is configured to provide the cage with resistance to a rotation following the driven gear when energized, to allow sidewalls of the cannelures to squeeze the plurality of pin rollers to tighten the output half shaft.

In some embodiments, the electromagnetic switching mechanism includes an electromagnetic coil and an electromagnetic chuck. The electromagnetic coil is fixed to the housing. The electromagnetic chuck is sleeved outside the cage and is in transmission connection with the cage through a circumferential limiting structure. The circumferential limiting structure includes a limiting groove and a limiting protrusion. The limiting groove extends along an axial direction of the cage, to allow the electromagnetic chuck to slide along the axial direction of the cage under an action of the electromagnetic coil.

In some embodiments, the vehicle driving apparatus further includes a return mechanism, and the return mechanism includes a spacer and a return elastic element. The spacer is fixed outside the electromagnetic chuck by means of snap-in connection. The return elastic element is sleeved outside of the driven gear shaft and is located between the spacer and the driven gear. The driven gear is provided with a first stop pin on a side facing the spacer, and the first stop pin is used for transmission connection with the return elastic element. The spacer is provided with a second stop pin on a side facing the driven gear, and the second stop pin is used for transmission connection with the return elastic element.

On the other aspect, embodiments of the disclosure provide a vehicle driving apparatus, including a housing; and a driving gear, a driven gear, a driven gear shaft, an output half shaft, a roller cage assembly, and an electromagnetic switching mechanism which are all located inside the housing. The driving gear and the driven gear are meshed for transmission connection. The roller cage assembly is sleeved on an inner side of the driven gear shaft. The roller cage assembly includes a cage, a roller group and an annular elastic element. The roller group includes a plurality of pin rollers, and a side surface of each pin roller is provided with a groove for mounting the annular elastic element. The roller group and the annular elastic element both are mounted on the cage. In a radial direction of the cage, the annular elastic element is located between the cage and the roller group, to allow the cage to be in transmission connection with the driven gear shaft via the roller group. An inner surface of the driven gear shaft is provided with a plurality of cannelures, and one cannelure is used for accommodating one pin roller in the roller group. The output half shaft is sleeved on an inner side of the cage. The electromagnetic switching mechanism is configured to provide the cage with resistance to a rotation following the driven gear when energized, to allow sidewalls of the cannelures to squeeze the plurality of pin rollers to tighten the output half shaft.

On another aspect, embodiments of the disclosure provide a vehicle, including the vehicle driving apparatus as described in any of the above embodiments.

### BRIEF DESCRIPTION OF FIGURES

FIG. 1 is a first exploded view of a vehicle driving apparatus according to embodiments of the disclosure.

FIG. 2 is a second exploded view of a vehicle driving apparatus according to embodiments of the disclosure.

FIG. 3 is an exploded view of a vehicle driving apparatus with some structures hidden according to embodiments of the disclosure.

FIG. 4 is a cross-sectional view of a vehicle driving apparatus according to embodiments of the disclosure.

FIG. 5 is an enlarged view at circle A in FIG. 4.

FIG. 6 is a cross-sectional view of an assembly structure including an output half shaft, a roller cage assembly and a driven gear in a vehicle driving apparatus according to embodiments of the disclosure.

FIG. 7 is a schematic diagram of a transmission structure of a vehicle driving apparatus in a two-wheel drive state according to embodiments of the disclosure.

FIG. 8 is a schematic diagram of a transmission structure of a vehicle driving apparatus in a four-wheel drive state according to embodiments of the disclosure.

FIG. 9 is a schematic structural diagram of a vehicle driving apparatus according to embodiments of the disclosure.

FIG. 10 is a cross-sectional view along line B-B in FIG. 9.

FIG. 11 is an enlarged view at a circle C in FIG. 10.

FIG. 12 is a schematic structural diagram of a vehicle driving apparatus with a housing hidden according to embodiments of the disclosure.

FIG. 13 is an enlarged view at a circle D in FIG. 12.

FIG. 14 is a schematic diagram of a stacked structure of a wear-resistant block in a vehicle driving apparatus according to embodiments of the disclosure.

FIG. 15 is a schematic diagram of a stacked structure of another wear-resistant block in a vehicle driving apparatus according to embodiments of the disclosure.

FIG. 16 is a first exploded view of another vehicle driving apparatus according to embodiments of the disclosure.

FIG. 17 is a second exploded view of another vehicle driving apparatus according to embodiments of the disclosure.

FIG. 18 is a schematic structural diagram of a vehicle according to embodiments of the disclosure.

### REFERENCE SIGNS

100 - housing; 200 - driven gear axial adjusting mechanism; 300 - driving gear; 400 - driven gear; 500 - output half shaft; 600 - roller cage assembly; 700 - electromagnetic switching mechanism; 800 - return mechanism; 110 - a housing cover; 120 - housing base; 111 - adjusting hole; 111a - first hole section; 111b - second hole section; 112 - boss; 210 - adjusting component; 220 - wear-resistant block; 220a - bending portion; 211 - adjusting bolt; 212 - adjusting nut; 213 - a sealing ring; 211a - adjusting plug; 221 - wear-resistant layer; 222 - vibration-absorbing layer; 223 - support layer; 224 - protective layer; 310 - input shaft bearing; 410 - driven gear shaft; 411 - cannelure; 420 - first stop pin; 510 - positioning sleeve; 520 - output half-shaft bearing; 610 - cage; 611 – pin roller placement groove; 612 - elastic element placement groove; 613 - limiting groove; 620 - pin roller; 630 - annular elastic element; 710 - electromagnetic coil; 720 - electromagnetic chuck; 721 - limiting protrusion; 722 – clamping jaw; 810 – spacer; 820 - return elastic element; 811 - second stop pin; 812 - slot; 821 - notch; 1 - vehicle driving apparatus; 2 - power source; 3 - rear differential; 4 - wheel.

### DETAILED DESCRIPTION

The technical solutions in the embodiments of the disclosure will be clearly and completely described below in conjunction with the accompanying drawings in the embodiments of the disclosure. It is clear that the described embodiments are only part, not all, of the embodiments of the disclosure. Based on the embodiments in the disclosure, all other embodiments obtained by a person skilled in the art without creative work fall within the scope of protection of the disclosure. In the description of the embodiments of the disclosure, unless otherwise indicated, "/" means or, for example, A/B may mean A or B. "And/or" in the description is merely an association that describes the associated objects, indicating that there can be three kinds of relationships, for example, A and/or B, which can dedicate: a case with only A, a case with both A and B, and a case with only B. Further, in the description of the embodiment of the disclosure, "plurality" refers to two or more than two.

Hereinafter, the terms "first" and "second" are used for descriptive purposes only and should not be construed as implying relative importance or implying the quantity of technical features indicated. Thus, the features that are limited to "first" and "second" may explicitly or implicitly include one or more of described features.

Based on the number of driving wheels, vehicles can be categorized as two-wheel drive (2WD) or four-wheel drive (4WD). In 2WD systems, power from the engine is transmitted through the gearbox to either the front or rear differential, which then distributes the power to two wheels (front or rear). However, 2WD vehicles may experience wheel slip in challenging terrain, thereby reducing off-road capability. While for the 4WD systems, when encountering adverse road conditions, the increased number of driving wheels improves tire-to-ground friction, minimizing slip and boosting off-road performance. In the existing 4WD systems, power from the engine is transmitted through the gearbox to a transfer case, which then distributes the power to the front and rear differentials before delivering it to the wheels.

The 4WD systems improve the off-road capability compared with the 2WD systems. However, the additional 4WD components increase vehicle weight, power loss, fuel consumption, and manufacturing costs. Furthermore, during paved-road turns, the rotational speed difference between front and rear wheels can induce tire scrub if 4WD remains engaged. This not only accelerates tire wear but also elevates the risk of handling instability.

In view of this, the vehicle driving apparatus according to embodiments of the disclosure belongs to the Part-Time 4WD, which can deliver higher torque transmission and provide enhanced escape capability, and allow 2WD mode engagement on well-paved roads to optimize fuel efficiency, reduce tire wear, and improve driving safety.

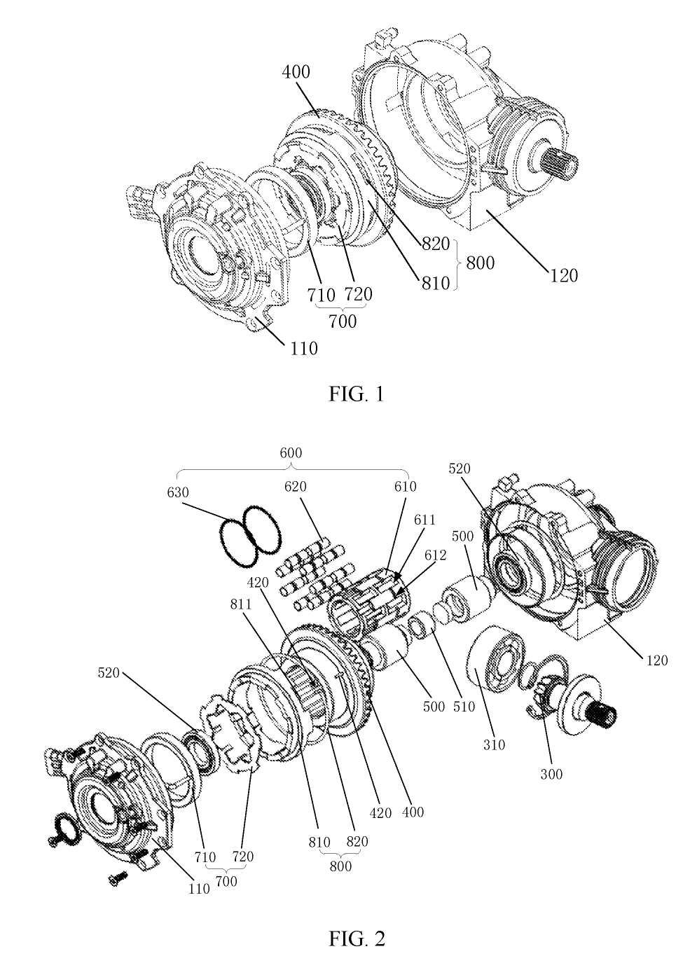

In some embodiments, as shown in FIGS. 1 – 3, embodiments of the disclosure provide a vehicle driving apparatus, including: a housing 100; and a driving gear 300, a driven gear 400, a driven gear shaft 410, an output half-shaft 500, a roller cage assembly 600 and an electromagnetic switching mechanism 700 which are all located inside the housing 100.

The driving gear 300 and the driven gear 400 are meshed for transmission connection.

The roller cage assembly 600 is sleeved on an inner side of the driven gear shaft 410. The roller cage assembly 600 includes a cage 610, a roller group and an annular elastic element(s) 630. The roller group includes a plurality of pin rollers 620, and a side surface of each pin roller 620 is provided with a groove for mounting the annular elastic element 630. The roller group and the annular elastic element 630 both are mounted on the cage 610. In a radial direction of the cage 610, the annular elastic element 630 is located between the cage 610 and the roller group, to allow the cage 610 to be in transmission connection with the driven gear 400 via the roller group. An inner surface of the driven gear shaft is provided with a plurality of cannelures 411, and each cannelure is used for accommodating one pin roller 620 in the roller group.

The output half shaft 500 is sleeved on an inner side of the cage 610.

The electromagnetic switching mechanism 700 is configured to provide the cage 610 with resistance to a rotation following the driven gear 400 when energized, to allow sidewalls of the cannelures to squeeze the plurality of pin rollers 620 to tighten the output half shaft 500.

In some embodiments, as shown in FIGS. 1 – 3, the vehicle driving apparatus according to embodiments of the disclosure includes a housing 100; and a driving gear 300, a driven gear 400, a driven gear shaft 410, an output half shaft 500, a roller cage assembly 610, and an electromagnetic switching mechanism 700 which are all within the housing 100.

The driving gear 300 is configured for power input and is supported via an input shaft bearing 310.

The driven gear 400 and the driving gear 300 are meshed for transmission connection. A driven gear shaft 410 is fixed inside a shaft hole of the driven gear 400. In some embodiments, the driving gear 300 and the driven gear 400 are integrated as a one-piece structure.

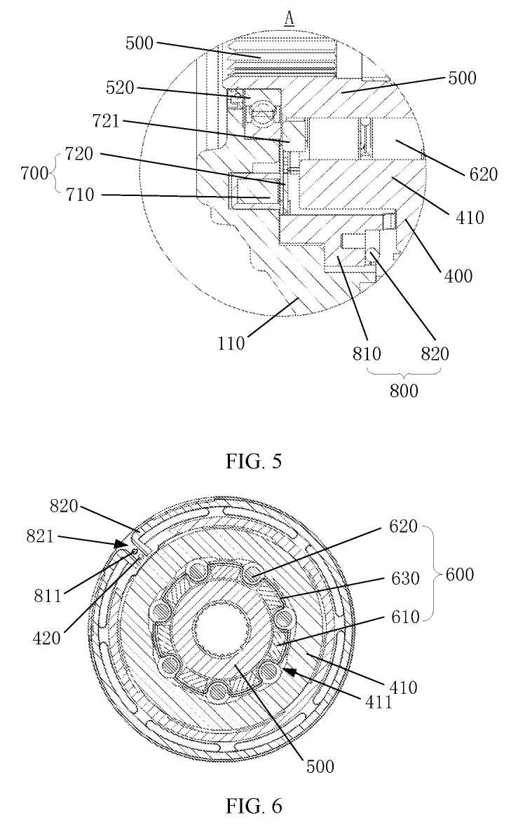

There two output half shafts 500 for connecting axles of a vehicle respectively and are supported inside the housing 100 via an output half-shaft bearing 520. The two output half shafts 500 are axially connected by a positioning sleeve 510 and are rotatable relative to each other. The output half shafts 500 are configured to be in a transmission connection with the driven gear shaft 410 via the roller cage assembly 600 under an action of the electromagnetic switching mechanism 700, as shown in FIGS. 4 and 5.

The roller cage assembly 600 includes a cage 610, a roller group(s) and an annular elastic element(s) 630. The roller group includes a plurality of pin roller 620, and a side surface of each pin roller 620 is provided with a groove for mounting the annular elastic element 630. The cage 610 is formed with pin roller placement grooves 611 for mounting the roller group(s). One pin roller placement groove 611 is mounted with one pin roller 620. As shown in FIG. 2, the roller cage assembly 600 includes two roller groups which are distributed with a gap along an axial direction of the roller cage assembly 600. The cage 610 is formed with a groove, for mounting the annular elastic element 630, which cooperates with a groove on a side surface of the pin roller 620 to together form an elastic element placement groove 612. The elastic element placement groove 612 is connected with the pin roller placement groove 611. When assembling the roller cage assembly 600, first the annular elastic element 630 is fixed in the elastic element placement groove 612, and then the pin roller 620 is pressed into the pin roller placement groove 611. The annular elastic element 630 always provides the pin roller 620 with a radial force away from the axis of the cage 610. That is, the annular elastic element 630 always provides the pin roller 620 with a radially outward force to make the pin roller 620 to fit with cannelures 411 of the driven gear shaft 410. In some embodiments, each pin roller 620 is provided with one elastic element placement groove 612 cooperating with the annular elastic element 630. In some embodiments, the annular elastic element 630 is a wire spring.

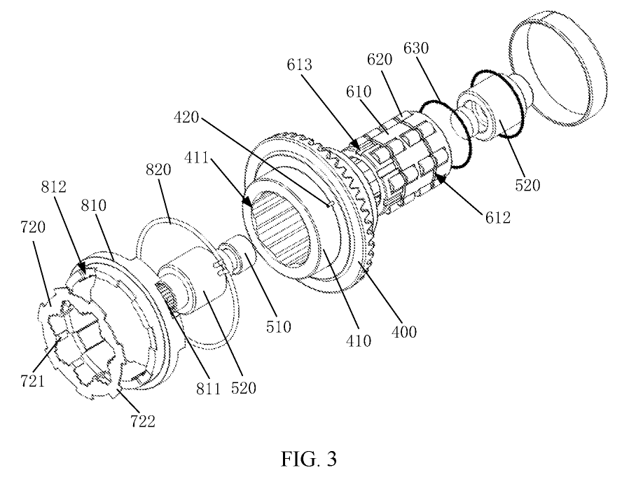

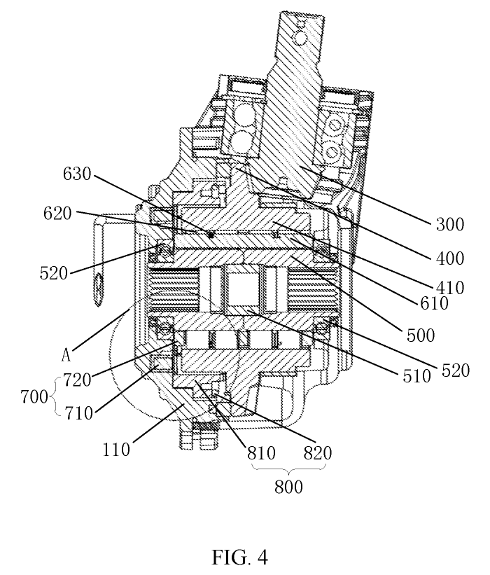

In some embodiments, the inner surface of the driven gear shaft 410 is provided with a plurality of cannelures 411, the cannelure 411 extends axially along the axial direction of the driven gear shaft 410, and one groove 411 accommodates one pin roller 620 in the roller group, as shown in FIG. 6. In some embodiments, two roller groups are shown in FIG. 3, where one cannelure 411 accommodates one pin roller 620 in the roller group and one pin roller 620 in another roller group.

In the vehicle drive apparatus according to the embodiments of the disclosure, the electromagnetic switching mechanism 700 has a power-on state and a power-off state, so that the apparatus has two driving modes of two-wheel drive (2WD) and four-wheel drive (4WD).

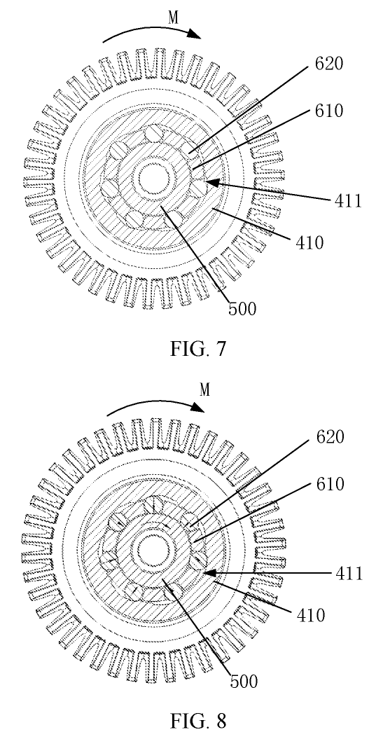

When the electromagnetic switching mechanism 700 is powered off, the cage 610 cannot be provided with resistance, and the power transmission process is as follows: the driving gear 300 drives the driven gear 400 to rotate, the gear shaft of the driven gear 400 drives the cage 610 to rotate through the pin roller 620, because the annular elastic element 630 gives the pin roller 620 a force far away from the axis, so that the pin roller 620 does not produce pressure on the output half shaft 500, and the output half shaft 500 does not rotate with the pin roller 620. That is, the power of the driven gear 400 is not transmitted to the output half shaft 500, and the apparatus is in the 2WD mode at this moment. As shown in FIG. 7, the driven gear 400 rotates along the direction M, and the output half shaft 500 does not rotate with the driven gear shaft 410.

When the electromagnetic switching mechanism 700 is powered on, the cage 610 can be provided with resistance, and the power transmission process is as follows: the driving gear 300 drives the driven gear 400 to rotate, the gear shaft of the driven gear 400 drives the cage 610 to rotate through the pin roller 620. However, because the cage 610 is subjected to resistance, the rotation speed is slower than that of the driven gear shaft 410, and the sidewalls of the cannelure 411 can squeeze the pin roller 620 at this moment, so that the pin roller 620 extrudes the output half shaft 500 towards the axis of the cage 610, until the output half shaft 500 is tightened, the output half shaft 500 rotates with the driven gear shaft 410, that is, the power of the driven gear 400 is transmitted to the output half shaft 500, and the apparatus is in 4WD mode at this moment. As shown in FIG. 8, the driven gear 400 rotates along the direction M, and the output half shaft 500 rotates with the driven gear shaft 410.

In some embodiments, the electromagnetic switching mechanism 700 includes an electromagnetic coil 710 and an electromagnetic chuck 720.

The electromagnetic coil 710 is fixed to the housing 100. The electromagnetic chuck 720 is sleeved outside the cage 610 and is in transmission connection with the cage 610 through a circumferential limiting structure.

The circumferential limiting structure includes a limiting groove 613 and a limiting protrusion 721. The limiting groove extends along the axial direction of the cage 610, to allow the electromagnetic chuck 720 to slide along the axial direction of the cage 610 under an action of the electromagnetic coil 710.

In some embodiments, as shown in FIGS. 3 - 5, the electromagnetic switching mechanism 700 includes an electromagnetic coil 710 and an electromagnetic chuck 720. The electromagnetic coil 710 is fixed to a housing cover 110. The electromagnetic chuck 720 is in sliding connection with the cage 610 through a circumferential limiting structure. As shown in FIG. 3, the outer surface of the end portion of the cage 610 is formed with limiting grooves 613 extending along the axial direction of the cage 610. An inner surface of the electromagnetic chuck 720 is connected with limiting protrusions 721 which are in sliding fit with the limiting grooves 613. When the electromagnetic coil 710 is powered off, there is a gap between the electromagnetic coil 710 and the electromagnetic chuck 720. When the electromagnetic coil 710 is powered on, magnetic attraction force is produced to make the electromagnetic chuck 720 move along the axial direction of the cage 610 to the electromagnetic coil 710, until absorbed by the electromagnetic coil 710. At this moment, there is sliding friction between the electromagnetic coil 710 and the electromagnetic chuck 720. This sliding friction force can hinder the cage 610 from rotating with the driven gear shaft 410, thereby making the cage 610 slow down relative to the driven gear shaft 410.

When the vehicle driving apparatus is applied to the vehicle and the vehicle is in four-wheel drive mode, when the vehicle turns a big corner, the left front wheel and the right front wheel travel differently. Take the vehicle left turn as an example, when the vehicle turns left, the distance that the left wheel has traveled is much less than the distance that the right wheel has travelled, the left wheel and the right wheel have a speed difference at this moment, and then the two output half shafts 500 of the vehicle driving apparatus have a speed difference, because the pin roller 620 is squeezed by the cannelure 411 and then holds the output half shaft 500 and the frictional force produced is limited, when the right side output half shaft 500 is subjected to the torque from the tire being too large, the pin roller 620 on the cage 610 cannot tighten the output half shaft 500, so that the rotation speeds of two output half shafts 500 are inconsistent, to avoid the left and right tires jumping and excessive wear. Furthermore, when the vehicle is overloaded, the output power of the engine is too large, and the pin rollers 620 in the cage 610 cannot tighten the output half shaft 500, separation can be realized, avoiding the damage of the whole transmission system. Therefore, the vehicle driving apparatus according to the disclosure has the function of two-way overtaking clutch in four-wheel drive mode, that is, the vehicle can realize overtaking clutch in forward and backward directions, not only can prevent excessive torque from damaging the transmission system, but also can realize the function of left and right differential in four-wheel drive mode, and reduce the wear of tires.

In some embodiments, the vehicle driving apparatus further includes a return mechanism 800, and the return mechanism 800 includes a spacer 810 and a return elastic element 820.

The spacer 810 is fixed outside the electromagnetic chuck 720 by means of snap-in connection.

The return elastic element 820 is sleeved outside of the driven gear shaft 410 and is located between the spacer 810 and the driven gear 400. The driven gear 400 is provided with a first stop pin 420 on a side facing the spacer 810, and the first stop pin 420 is used for transmission connection with the return elastic element 820. The spacer 810 is provided with a second stop pin 811 on a side facing the driven gear 400, and the second stop pin 811 is used for transmission connection of the return elastic element 820.

In some embodiments, as shown in FIGS. 1 and 2, the vehicle driving apparatus according to embodiments of the disclosure includes a housing 100 and a driving gear 300, a driven gear 400, a driven gear shaft 410, an output half shaft 500, a roller cage assembly 600, an electromagnetic switching mechanism 700 and a return mechanism 800 located inside the housing 100. The electromagnetic switching mechanism 700 includes an electromagnetic coil 710 and an electromagnetic chuck 720, and the return mechanism 800 includes a spacer 810 and a return elastic element 820, the spacer 810 is circumferentially fixed with the electromagnetic chuck 720, and the return elastic element 820 is positioned between the spacer 810 and the driven gear 400. In some embodiments, an outer surface of the electromagnetic chuck 720 is formed with a clamping jaw 722, and a slot 812 for matching with the clamping claw 722 is formed on the spacer 810, so that the spacer 810 and the electromagnetic chuck 720 are circumferentially fixed.

The return mechanism 800 is used for realizing that when the apparatus switches from four-wheel drive mode to two-wheel drive mode, facilitate the pin roller 620 in the cage 610 to return to the position in the two-wheel drive state.

The spacer 810 and the return elastic element 820 are both sleeved outside the driven gear shaft 410, and along the axial direction. The return elastic element 820 is positioned between the spacer 810 and the driven gear 400. The axial end face of the driven gear 400 is formed with a first stop pin 420, and the axial end face of the spacer 810 is formed with a second stop pin 811.

When the apparatus is in the two-wheel drive state, the electromagnetic coil 710 is not energized and does not produce magnetic attraction. The apparatus has two power transmission routes. The first power transmission route is that the driving gear 300 drives the driven gear 400 to rotate, when the driven gear 400 rotates, the return elastic element 820 is driven to rotate by the first stop pin 420, the return elastic element 820 rotates and drives the spacer 810 to rotate through the second stop pin 811, and the spacer 810 drives the electromagnetic chuck 720 to rotate again. The second power transmission route is that the driving gear 300 drives the driven gear 400 to rotate, and the driven gear 400 drives the cage 610 to rotate through the pin roller 620.

When the apparatus is in the four-wheel drive state, the electromagnetic coil 710 is energized to generate magnetic attraction. The two power transmission routes of the apparatus are as follows. The first power transmission route is that, the driving gear 300 drives the driven gear 400 to rotate, when the driven gear 400 rotates, the return elastic piece 820 is driven to rotate through the first stop pin 420, the return elastic element 820 rotates and drives the spacer 810 to rotate through the second stop pin 811, and the spacer 810 drives the electromagnetic chuck 720 to rotate again, but because the electromagnetic chuck 720 is adsorbed to the surface of the electromagnetic coil 710, there is friction between the electromagnetic coil 710 and the electromagnetic chuck 720, and this friction force is greater than the elastic force from the return elastic element 820, and further because the electromagnetic coil 710 cannot rotate due to being fixed to the housing cover 110, the friction force makes the electromagnetic chuck 720 have a tendency to remain unmoved. Further because the electromagnetic chuck 720 is synchronously rotated and connected with the cage 610, the cage 610 also has a tendency to remain unmoved relative to the driven gear 400. The tendency to remain unmoved here is not that there is no actually rotating, but can be roughly considered as that the rotational speed of the cage 610 is slower than that of the driven gear 400. The second power transmission route is, the driving gear 300 drives the driven gear 400 to rotate, and the driven gear 400 drives the cage 610 to rotate through the pin roller 620, but because the cage 610 is slower than the driven gear 400, with reference to FIG. 8, the side surfaces of the cannelures 411 on the driven gear 400 can produce an inward extrusion force to the pin rollers 620, and then the pin rollers 620 tighten the two output half-shafts 500 in the middle along the radial direction, thus the power is then transmitted from the pin rollers 620 to the two output half-shafts 500.

When switching from four-wheel drive mode to two-wheel drive mode, the return elastic element 820 can drive the spacer 810 to return to the position in the two-wheel drive mode, so as to prevent the return position from being untimely.

In some embodiments, the return elastic element 820 is an annular structure with a notch 821, and the first stop pin 420 and the second stop pin 811 are both positioned at the notch 821, as shown in FIG. 6. In some embodiments, two ends of the return elastic elements 820 are provided with bending segments for cooperating with the first stop pin 420 and the second stop pin 811 to realize power transmission.

In some embodiments, the return elastic element is a return spring.

The vehicle driving apparatus according to the embodiments of the disclosure has the following beneficial effects:
1. manually switching between two-wheel drive mode and four-wheel drive mode are allowed based on the vehicle driving apparatus, and four-wheel drive mode can be enabled when encountering muddy road sections, which has stronger grip and improves off-road performance;
2. the differential of the vehicle is combined with the four-wheel drive system based on the vehicle driving apparatus, which reduces the cost of the four-wheel drive system, reduces the weight and reduces the volume;
3. the vehicle driving apparatus belongs to the part-time four-wheel drive system, which can transmit large torque, strong ability to get out of trouble, and can use two-wheel drive mode when the road conditions are good to save fuel consumption;
4. the function of differential speed between the left and right wheels in the mode of two-wheel drive can be realized;
5. in the mode of four-wheel drive, the function of two-way overtaking clutch can be realized, which can achieve overtaking clutch in both forward and backward directions, thus not only preventing excessive torque from damaging the transmission system, but also realizing the function of left and right differential in the case of four-wheel drive, and reducing the wear and tear of tires; and
6. when switching from the four-wheel drive mode to the two-wheel drive mode, the return elastic elements can assist the pin roller to return to the position in two-wheel drive mode.

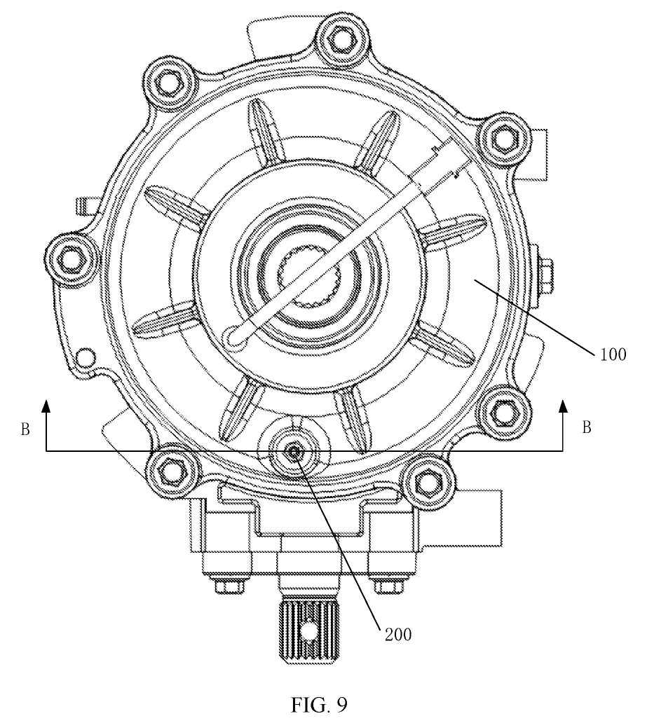

In some embodiments, as shown in FIGS. 9 - 13 , the embodiments of the disclosure provide a vehicle driving apparatus, including: a housing 100 ; a driven gear axial adjusting mechanism 200 ; and a driving gear 300 and a driven gear 400 both located inside the housing 100 . The driving gear 300 and the driven gear 400 are meshed for transmission connection.

The driven gear axial adjusting mechanism 200 includes an adjusting component 210 and a wear-resistant block 220. The wear-resistant block 220 is fixed inside the housing 100 via the adjusting component 210, and the wear-resistant block 220 abuts against an axial end face of the driven gear 400.

In the vehicle driving apparatus according to embodiments of the disclosure, the driving gear 300 and the driven gear 400 are meshed for transmission connection inside the housing 100, the driven gear axial adjusting mechanism 200 makes the axial position of the driven gear 400 adjustable, so that the stable transmission between the driving gear 300 and the driven gear 400 can be guaranteed. Specifically, the driven gear axial adjusting mechanism 200 includes the adjusting component 210 and the wear-resistant block 220. The wear-resistant block 220 is fixed to the housing 100 through the adjusting component 210. The adjusting component 210 can adjust the axial distance between the wear-resistant block 220 and the driven gear 400 to ensure that the wear-resistant block 220 abuts against the axial end face of the driven gear 400, thereby ensuring that the driven gear 400 is always in a stable transmission axial position, avoiding axial jumping of the driven gear 400 caused by gear wear, and reducing the vibration and noise of the entire drive system.

In some embodiments, the housing 100 includes a housing cover 110 with an adjusting hole 111.

The adjusting component 220 includes an adjusting bolt 211 and an adjusting nut 212.

A first end of the adjusting bolt 211 passes through the adjusting hole 111 and extends outside the housing 100, and a second end of the adjusting bolt 211 connects with the wear-resistant block 220. The second end of the adjusting bolt 211 is in sealing connection with the adjusting hole 111.

The adjusting nut 212 is fixed to the housing cover 110 by means of a thread fit with the first end of the adjusting bolt 211.

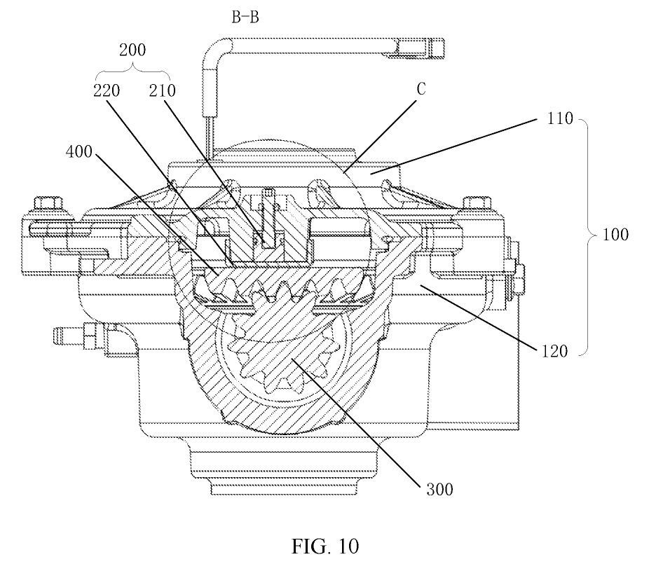

In some embodiments, as shown in FIG. 10, the housing 100 includes a housing cover 110 and a housing base 120. The housing base 120 has an accommodating space, and the housing cover 110 is closed to the housing base 120 and locked by a connecting component. In some embodiments, the connecting component is a bolt. The driving gear 300 and the driven gear 400 are assembled inside the housing 100 and meshed for transmission connection. The wear-resistant block 220 in the driven gear axial adjusting mechanism 200 is fixed to the housing cover 110 through the adjusting component 210 and abuts against the axial end face of the driven gear 400. That is, during the meshing transmission process between the driving gear 300 and the driven gear 400, the wear-resistant block 220 always contacts the axial end face of the driving gear 300. When the gear wears out, the axial dimension of the driven gear 400 decreases, making it prone to axial runout when meshing with the driving gear 300. In the embodiment of the disclosure, the driven gear axial adjusting mechanism 200 can bring the wear-resistant block 220 to be in contact with the axial end face of the driven gear 400 through the adjusting component 210, thereby ensuring the axial position of the driven gear 400 and reducing the vibration and noise when the driven gear 400 meshes with the driving gear 300.

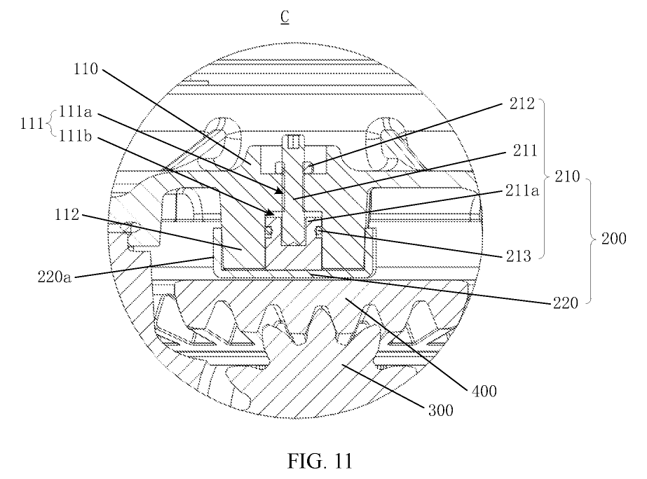

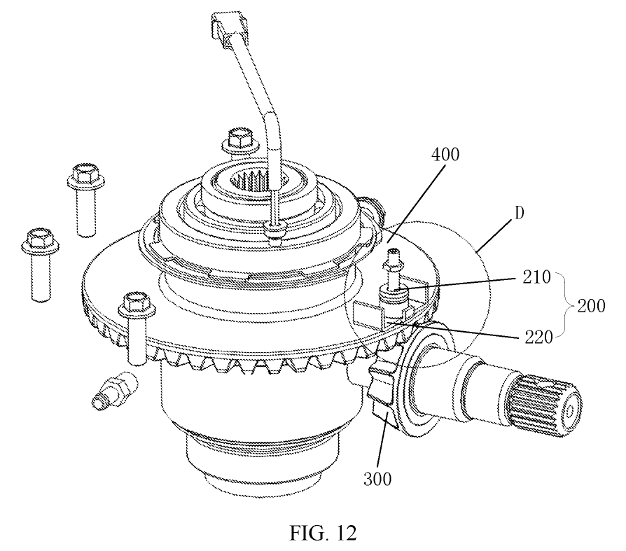

As shown in FIG. 11, the adjusting component 210 includes an adjusting bolt 211 and an adjusting nut 212, and an adjusting hole 111 matched with an adjusting bolt 211 is formed on the housing cover 110. The adjusting hole 111 includes a first hole section 111a and a second hole section 111b, and the second hole section 111b is positioned at a side of the housing cover 110 towards the housing base 120. The radial size of the second hole section 111b is greater than that of the first hole section 111a. The adjusting bolt 211 includes a rod portion and an adjusting plug 211a, and the rod portion is provided with an external thread for thread fit with the adjusting nut 212. The adjusting plug 211a is connected with the wear-resistant block 220, and sealed in the second hole section 111b. In some embodiments, the adjusting plug 211a and the rod portion are in thread connection to form an integral structure. In other embodiments, the adjusting plug 211a and the rod portion are integrated as a one-piece structure. In another embodiment, the adjusting plug 211a is connected with the second hole section 111b through a sealing ring 213, as shown in FIG. 11.

In some embodiments, the axial dimension of the second hole section 111b is greater than the axial dimension of the adjusting plug 211a.

In some embodiments, a side of the housing cover 110 facing away from the housing 100 is formed with a sinking platform for accommodating the adjusting nut 212. The thickness of the adjusting nut 212 is smaller than the depth of the sinking platform, so that the adjusting nut 212 is embedded in the housing cover 110, avoiding the high displacement of the wear-resistant block 220 caused by accidental contact with the adjusting nut 212.

In some embodiments, a boss 112 is provided on a side of the housing cover 110 facing the driven gear 400.

The wear-resistant block 220 includes multiple bending portions 220a, which are arranged in a circular manner around the adjusting bolt 211 to form an accommodation space for accommodating the boss 112.

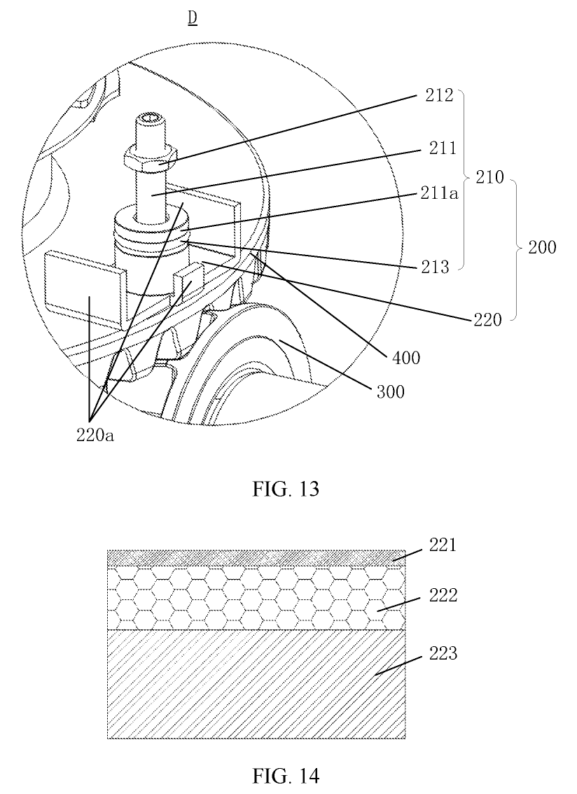

In some embodiments, as shown in FIGS. 11 and 13, the housing cover 110 has a boss 112 protruding towards the housing base 120, and the wear-resistant block 220 is fixed to the boss 112 through an adjusting component 210. The wear-resistant block 220 includes multiple bending portions 220a, which are bent towards the adjusting component 210 and surrounding the outer side of the boss 112, facilitating the axial height adjustment of the wear-resistant block 220 and balancing the force on the wear-resistant block 220.

In some embodiments, as shown in FIG. 14, the wear-resistant block 220 includes a wear-resistant layer 221, a vibration -absorbing layer 222, and a support layer 223 that are in a stack. The wear-resistant layer 221 abuts against the axial end face of the driven gear 400 on the side facing away from the vibration-absorbing layer 222.

In some embodiments, as shown in FIG. 14, the wear-resistant block 220 includes a wear-resistant layer 221, a vibration-absorbing layer 222 and a support layer 223 arranged in a stack. The wear-resistant layer 221 is in direct contact with the driven gear 400. In the transmission process of the driven gear 400, there is a sliding friction between the wear-resistant layer 221 and the driven gear 400. Therefore, the wear-resistant layer 221 needs to be made of materials with low friction and good wear resistance. The vibration-absorbing layer 222 provides vibration-absorbing performance for the wear-resistant block 220, and can reduce the vibration of the driven gear 400 that is attached to the wear-resistant block 220. The support layer 223 provides the skeleton of the wear-resistant block 220, and provides a supporting effect for the wear-resistant block 220.

In some embodiments, the material of the wear-resistant layer 221 includes polytetrafluoroethylene and lead; and/or, the material of the vibration-absorbing layer 222 includes tin bronze; and/or, the material of the support layer 223 includes mild steel.

In some embodiments, the material of the wear-resistant layer 221 is polytetrafluoroethylene and lead, with low friction, good wear resistance, high flatness, and self-lubricating properties. Even if the lubricating oil cannot reach the position, it will not affect the friction performance of the wear-resistant block 220.

In some embodiments, the material of the vibration-absorbing layer 222 includes tin bronze, and the vibration-absorbing layer 222 is a powder layer that can provide vibration-absorbing performance.

In some embodiments, the wear-resistant block 220 further includes a protective layer 224 stacked on the side of the support layer 223 facing away from the vibration-absorbing layer 222.

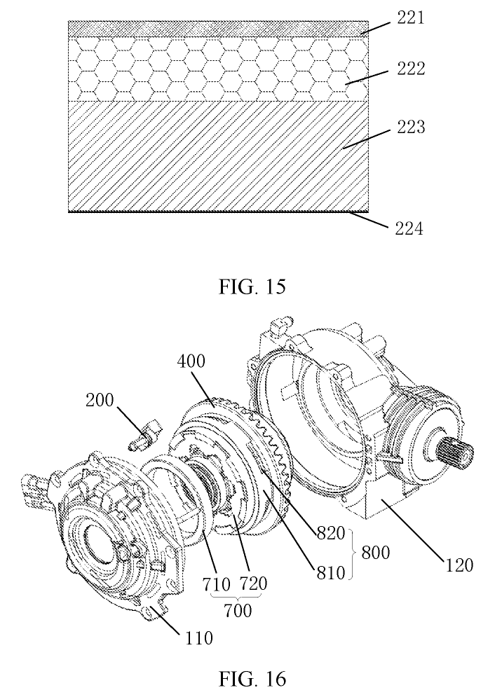

In some embodiment, as shown in FIG. 15, the wear-resistant block 220 includes a wear-resistant layer 221, a vibration-absorbing layer 222, a support layer 223, and a protective layer 224 that are in a stack. The protective layer 224 has certain corrosion resistance and rust prevention ability.

In some embodiments, the protective layer 224 includes an electroplated copper layer.

In some embodiments, the thickness of the wear-resistant layer 221 is less than that of the vibration-absorbing layer 222, the thickness of the vibration-absorbing layer 222 is less than the thickness of the support layer 223, and the thickness of the protective layer 224 is less than the thickness of the wear-resistant layer 221.

The vehicle driving apparatus provided in the embodiment of the disclosure has a driven gear axial adjusting mechanism, which can reduce the vibration of the gear and reduce the noise during transmission.

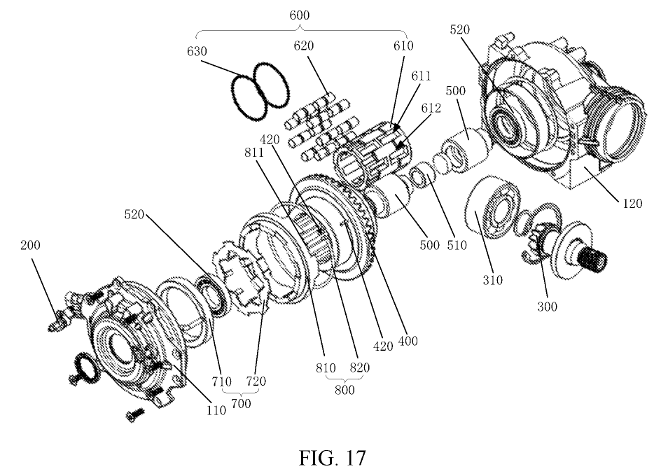

As shown in FIGS. 16-17, the vehicle driving apparatus provided in the embodiments of the disclosure further includes a driven gear shaft 410, an output half shaft 500, a roller cage assembly 600 and an electromagnetic switching mechanism 700.

The driven gear shaft 410 is coaxially fixed in the shaft hole of the driven gear 400.

The roller cage assembly 600 is sleeved on the inner side of the driven gear shaft 410. The roller cage assembly 600 includes a cage 610, a roller group and an annular elastic element 630, and the roller group includes a plurality of pin rollers 620. The roller group and the annular elastic element 630 are both mounted on the cage 610. Along the radial direction of the cage 610, the annular elastic element 630 is positioned between the cage 610 and the roller group, so that the cage 610 is in transmission connection with the driven gear shaft 410 through the roller group. The inner surface of the driven gear shaft 410 is formed with a plurality of cannelures 411, and one cannelure 411 is used for accommodating one pin roller 620 in the roller group.

The output half shaft 500 is sleeved on the inner side of the cage 610.

The electromagnetic switching mechanism 700 is configured to provide the cage 610 with the resistance to a rotation following the driven gear 400 when energized, so that the sidewalls of the cannelures 411 squeeze the plurality of pin rollers 620 to tighten the output half shaft 500.

In this embodiment, the vehicle driving apparatus is provided with a driven gear axial adjusting mechanism 200, and the rest of the structure is the same as that described above, and is not repeated herein.

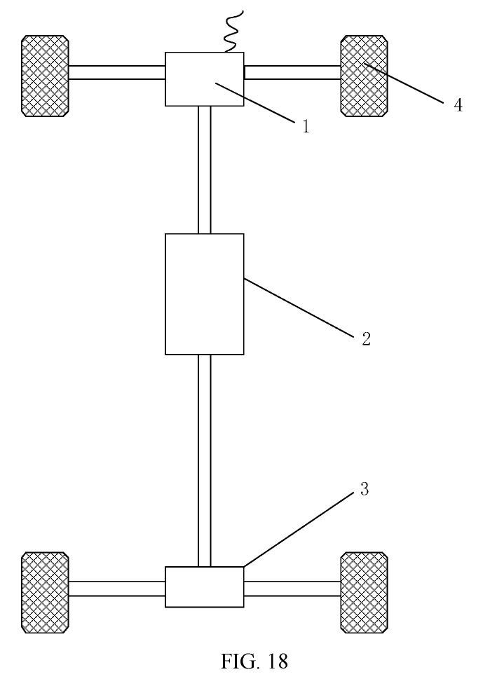

Embodiments of the disclosure further provide a vehicle, as shown in FIG. 18, including any one of the vehicle driving apparatuses described in the above embodiments.

In some embodiments, as shown in FIG. 18, the vehicle includes a vehicle driving apparatus 1, a power source 2, a differential 3, and four wheels 4. Power source 2 includes an engine and a reducer in transmission connection with the engine. Vehicle driving apparatus 1 is connected to power source 2 and installed between the two front wheels, while differential 3 is connected to power source 2 and installed between the two rear wheels. The vehicle driving apparatus 1 is equipped with left and right output half shafts on both sides, which have internal splines. The left and right output half shafts are connected to the wheel half shafts of the vehicle, and the wheel half shafts are connected to the wheels of the vehicle.

In some embodiments, the vehicle driving apparatus is installed on an all-terrain vehicle. The all-terrain vehicle is small and has strong off-road performance. The all-terrain vehicle requires good off-road performance and can travel on muddy, sandy, and gravel roads with weak grip. Therefore, a good four-wheel drive system is required. Also, because this type of vehicle has a small displacement and a smaller volume compared to cars, it is not possible to use four-wheel drive components such as the transfer case, differential, and coupler found in cars. The vehicle driving apparatus according to the embodiments of the disclosure has the advantages of small size, the ability to achieve left and right differential speed, the ability to switch between two wheel drive and four-wheel drive modes according to the user's needs, and the function of bidirectional overrunning clutch. It can be installed on all-terrain vehicles to reduce fuel consumption by using two wheel drive mode in good road conditions and four-wheel drive mode in bad road conditions, and has the functions of left and right differential speed and overrunning clutch.

Apparently, those skilled in the art can make various changes and modifications to the embodiments without departing from the spirit and scope of the disclosure. Thus, if such modifications and variations of the embodiments fall within the scope of the appended claims and their equivalents, the disclosure also intends to encompass these changes and variations.

What is claimed is:

1. A vehicle driving apparatus, comprising:
a housing;
a driven gear axial adjusting mechanism; and
a driving gear and a driven gear both located inside the housing;
wherein the driving gear and the driven gear are meshed for transmission connection;
the driven gear axial adjusting mechanism comprises:
an adjusting component, and
a wear-resistant block,
wherein the wear-resistant block is fixed inside the housing through the adjusting component, and the wear-resistant block abuts against an axial end face of the driven gear.

2. The vehicle driving apparatus according to claim 1, wherein the wear-resistant block comprises a wear-resistant layer, a vibration-absorbing layer, and a support layer arranged in a stack; and
a side of the wear-resistant layer facing away from the vibration-absorbing layer abuts against the axial end face of the driven gear.

3. The vehicle driving apparatus according to claim 2, wherein:
a material of the wear-resistant layer comprises polytetrafluoroethylene and lead; and/or
a material of the vibration-absorbing layer comprises tin bronze; and/or
a material of the support layer comprises mild steel.

4. The vehicle driving apparatus according to claim 2, wherein the wear-resistant block further comprises a protective layer stacked on a side of the support layer facing away from the vibration-absorbing layer.

5. The vehicle driving apparatus according to claim 4, wherein the protective layer comprises an electroplated copper layer.

6. The vehicle driving apparatus according to claim 2, wherein the housing comprises a housing cover provided with an adjusting hole;
the adjusting component comprises an adjusting bolt and an adjusting nut, wherein
a first end of the adjusting bolt passes through the adjusting hole and extends outside the housing;
a second end of the adjusting bolt connects the wear-resistant block and is in sealing connection with the adjusting hole; and
the adjusting nut is fixed to the housing cover by means of a thread fit with the first end of the adjusting bolt.

7. The vehicle driving apparatus according to claim 6, wherein the housing cover is provided with a boss on a side of the housing cover facing the driven gear; and
the wear-resistant block comprises a plurality of bending portions arranged in a circular manner around the adjusting bolt to form an accommodation space for accommodating the boss.

8. The vehicle driving apparatus according to claim 1, further comprising: a driven gear shaft, an output half shaft, a roller cage assembly, and an electromagnetic switching mechanism; wherein
the roller cage assembly is sleeved on an inner side of the driven gear shaft;
the roller cage assembly comprises a cage, a roller group and an annular elastic element; wherein
the roller group comprises a plurality of pin rollers, and a side surface of each pin roller is provided with a groove for mounting the annular elastic element;
the roller group and the annular elastic element are both mounted on the cage;
along a radial direction of the cage, the annular elastic element is located between the cage and the roller group, to allow the cage to be in transmission connection with the driven gear shaft through the roller group;
an inner surface of the driven gear shaft is provided with a plurality of cannelures, and each cannelure is used for accommodating one pin roller in the roller group;
the output half shaft is sleeved on an inner side of the cage;
and
the electromagnetic switching mechanism is configured, when energized, to provide the cage with resistance to a rotation following the driven gear, to allow sidewalls of the cannelures to squeeze the plurality of pin rollers to tighten the output half shaft.

9. The vehicle driving apparatus according to claim 8, wherein the electromagnetic switching mechanism comprises an electromagnetic coil and an electromagnetic chuck;
the electromagnetic coil is fixed to the housing;
the electromagnetic chuck is sleeved outside the cage and is in transmission connection with the cage through a circumferential limiting structure;
wherein the circumferential limiting structure comprises a limiting groove and a limiting protrusion, and the limiting groove extends along an axial direction of the cage, to allow the electromagnetic chuck to slide along the axial direction of the cage under an action of the electromagnetic coil.

10. The vehicle driving apparatus according to claim 9, further comprising a return mechanism;
wherein the return mechanism comprises a spacer and a return elastic element;
the spacer is fixed outside the electromagnetic chuck by means of snap-in connection;
the return elastic element is sleeved outside of the driven gear shaft and is located between the spacer and the driven gear;
the driven gear is provided with a first stop pin on a side facing the spacer, and the first stop pin is used for transmission connection with the return elastic element; and
the spacer is provided with a second stop pin on a side facing the driven gear, and the second stop pin is used for transmission connection with the return elastic element.

11. A vehicle driving apparatus, comprising:
a housing; and
a driving gear, a driven gear, a driven gear shaft, an output half shaft, a roller cage assembly, and an electromagnetic switching mechanism which are all located inside the housing;
wherein
the driving gear and the driven gear are meshed for transmission connection;
the roller cage assembly is sleeved on an inner side of the driven gear shaft;
the roller cage assembly comprises a cage, a roller group and an annular elastic element; wherein
the roller group comprises a plurality of pin rollers, and a side surface of each pin roller is provided with a groove for mounting the annular elastic element;
the roller group and the annular elastic element are both mounted on the cage;
along a radial direction of the cage, the annular elastic element is located between the cage and the roller group, to allow the cage to be in transmission connection with the driven gear shaft through the roller group;
an inner surface of the driven gear shaft is provided with a plurality of cannelures, and each cannelure is used for accommodating one pin roller in the roller group;
the output half shaft is sleeved on an inner side of the cage;
and
the electromagnetic switching mechanism is configured, when energized, to provide the cage with resistance to a rotation following the driven gear, to allow sidewalls of the cannelures to squeeze the plurality of pin rollers to tighten the output half shaft.

12. A vehicle, comprising the vehicle driving apparatus according to claim 1.

13. A vehicle, comprising the vehicle driving apparatus according to claim 11.
